(19) United States
(12) Patent Application Publication
(10) Pub. No.: US 2007/0058379 A1
(43) Pub. Date: Mar. 15, 2007

(54) Suspension cable retention method and apparatus for lighting

(76) Inventor: Gregg E. Laukhuf, Bryan, OH (US)

Correspondence Address: TAYLOR & AUST, P.C., 142 SOUTH MAIN STREET, P. O. BOX 560, AVILLA, IN, 46710, US

(21) Appl. No.: 11/511,167

(22) Filed: Aug. 28, 2006

Related U.S. Application Data
(60) Provisional application No. 60/712,578, filed on Aug. 30, 2005.

(51) Int. Cl. A47H 1/10; F21V 19/00

(52) U.S. Cl. 362/382; 248/317

(57) ABSTRACT

A linear light fixture mounting assembly and method of mounting includes a cable, a housing member, and an elastic member. The cable has a body and an end, and the end has a larger cross-sectional extent than the body. The housing member has a top surface and a bottom surface and defines a keyhole through the top and bottom surfaces. The keyhole has a circular portion and a narrower slot-shaped portion. The circular portion has a larger cross-sectional extent than the end of the cable. The end of the cable is positioned adjacent to the bottom surface and has a larger cross-sectional extent than the width of the narrower slot-shaped portion of the keyhole. The elastic member is attached to the bottom surface of the housing member and is located under the circular portion of the keyhole. The elastic member is configured for flexing in a downward direction and springing back. Additionally, the elastic member has a distal end adjacent to the end of the cable for retaining the end of the cable in the narrower slot-shaped portion of the keyhole.

### CROSS REFERENCE TO RELATED APPLICATIONS

This is a non-provisional application based upon U.S. provisional patent application Ser. No. 60/712,578, entitled “SUSPENSION CABLE RETENTION METHOD AND APPARATUS FOR LIGHTING”, filed Aug. 30, 2005.

### BACKGROUND OF THE INVENTION

1. Field of the Invention

The present invention relates to light fixtures, and, more particularly, to a suspension cable retention method and apparatus for light fixtures.

2. Description of the Related Art

Linear light fixtures such as fluorescent lights, etc., are often used for task lighting or accent lighting. They can be mounted over work spaces and in home environments.

Various techniques are used in mounting linear light fixtures. These mounting techniques include screwing the light fixture into a wall or ceiling, as well as anchoring a strap in cement and coupling that strap to a metal strap attached to the light fixture. Another technique involves securing retaining chains extending between a reflector pan and an L-shaped bracket on a channel attached to a ceiling and hiding and securing those chains in specially manufactured locking caps underneath the reflector pan.

Such mounting techniques, however, pose certain disadvantages. First, drilling holes in ceilings and/or walls requires extra tools including drills and drill bits and leaves undesirable holes. Filling such holes and painting will likely be necessary if a drilling mistake is made or if the light fixture is eventually removed from service. Second, additional, specially manufactured items are sometimes needed to secure the light fixture.

What is needed in the art is a method and an apparatus for quickly installing a linear light fixture.

### SUMMARY OF THE INVENTION

The present invention provides a method and an apparatus for quickly installing a linear light fixture.

The invention comprises, in one form thereof, a light fixture mounting assembly including a cable, a housing member, and an elastic member. The cable has a body and an end, and the end has a larger cross-sectional extent than the body. The housing member has a top surface and a bottom surface and defines a keyhole through the top and bottom surfaces. The keyhole has a circular portion and a narrower slot-shaped portion. The circular portion has a larger cross-sectional extent than the end of the cable. The end of the cable is positioned adjacent to the bottom surface and has a larger cross-sectional extent than the width of the narrower slot-shaped portion of the keyhole. The elastic member is attached to the bottom surface of the housing member and is located under the circular portion of the keyhole. The elastic member is configured for flexing in a downward direction and springing back. Additionally, the elastic member has a distal end adjacent to the end of the cable for retaining the end of the cable in the narrower slot-shaped portion of the keyhole.

The invention comprises, in another form thereof, a method of mounting a light fixture, including the steps of: pressing an end of a cable into and through a circular portion of a keyhole and onto an elastic member, wherein the elastic member flexes in a downward direction; sliding the end of the cable into a narrower slot-shaped portion of the keyhole, wherein the end of the cable clears the elastic member and the elastic member springs back to overlie the circular portion; and retaining the end of the cable in the narrower slot-shaped portion of the keyhole by a distal end of the elastic member.

An advantage of the present invention is that it provides for ease of assembly and disassembly.

Another advantage of the present invention is that it provides for quicker installation.

Another advantage of the present invention is that it provides for ease of manufacture.

Yet another advantage of the present invention is that it provides for lower cost.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a perspective view of a linear light with an embodiment of a suspension cable retention method and apparatus at each end of the linear light;

FIG. 2 is an enlarged, perspective view of a single end of the linear light with the suspension cable exploded from the light;

FIG. 3 is a fragmentary, cross-sectional side view of the linear light and an end of a suspension cable illustrating how the end of the suspension cable is inserted into a keyhole of the linear light; and

FIGS. 4 and 5 are fragmentary, cross-sectional side views of the linear light and an end of a suspension cable illustrating how the end of the suspension cable is inserted into, and retained within, a keyhole of the linear light.

Corresponding reference characters indicate corresponding parts throughout the several views. The exemplification set out herein illustrates one preferred embodiment of the invention, in one form, and such exemplification is not to be construed as limiting the scope of the invention in any manner.

### DETAILED DESCRIPTION OF THE INVENTION

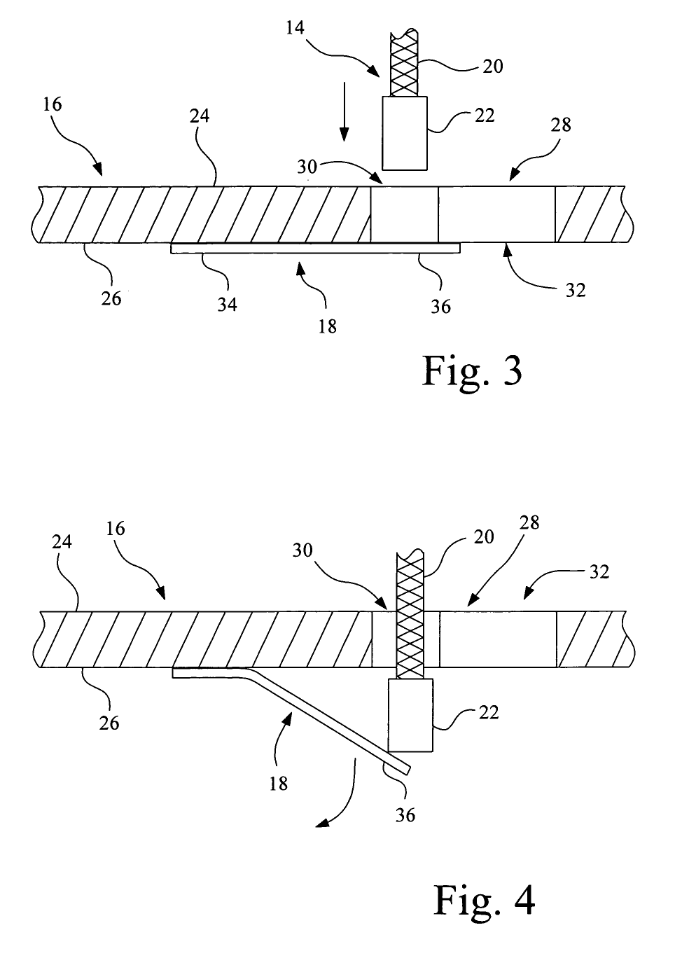

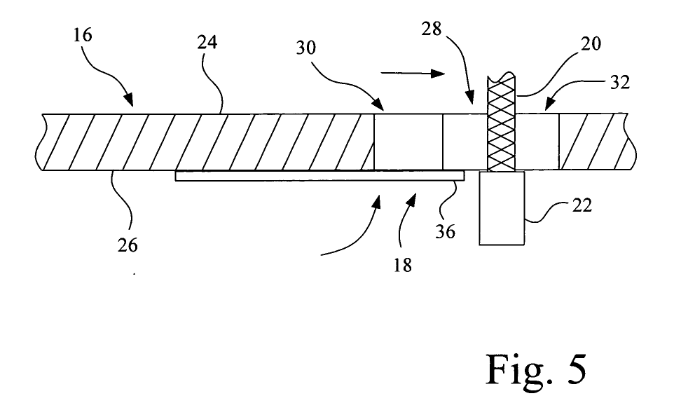

Referring now to the drawings, and more particularly to FIGS. 1-3, there is shown a linear light fixture 10 for suspension from a ceiling 12. Light fixture 10 generally includes a cable 14, a reflector pan 16, and a retainer spring 18.

Cable 14, which is made of steel aircraft cable, has a body 20 and an end 22, which is either swaged or crimped metal. End 22 has a larger cross-sectional extent than body 20. Cable 14, including both body 20 and end 22, is cylindrical in shape but is not necessarily cylindrical in all embodiments of the present invention. Furthermore, FIG. 1 shows a dual suspension cable on each end of a linear light fixture. The present invention can also be used with and applied to single point suspensions and to nonlinear light fixtures.

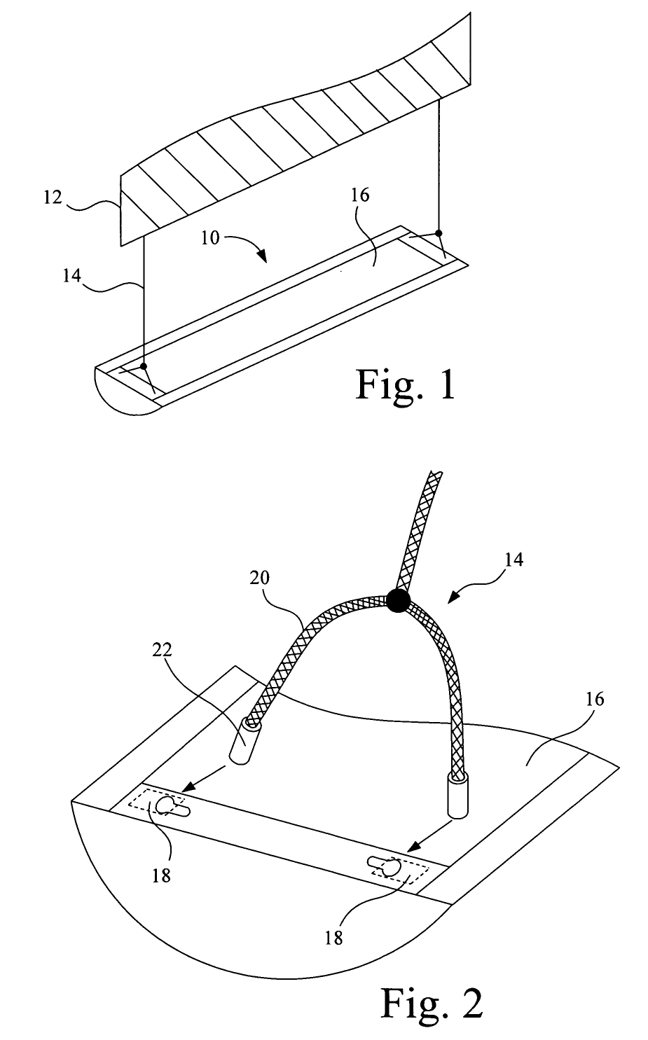

Reflector pan 16, which can be shaped sheet metal, has a top surface 24 and a bottom surface 26 and defines a keyhole 28 through top and bottom surfaces 24, 26. As shown in FIG. 2, reflector pan 16 contains a plurality of keyholes 28 but does not necessarily contain a plurality of keyholes 28 in all embodiments of the present invention. Keyhole 28 includes an enlarged portion 30 at one end connected to a narrow portion 32 at the other end, the width of enlarged portion 30 being greater than the width of narrow portion 32. Enlarged portion 30 has a larger cross-sectional extent than end 22 of cable 14. End 22, however, has a larger cross-sectional extent than the width of narrow portion 32 of keyhole 28. Enlarged portion 30 is approximately circular in shape, while narrow portion 32 is shaped as an elongated slot. Keyhole 28 is, thus, configured to receive end 22 of cable 14 through enlarged portion 30 and to retain end 22 in narrow portion 32.

Retainer spring 18 includes a proximal end 34 and a distal end 36. Retainer spring 18 is attached to bottom surface 26 of reflector pan 16 at proximal end 34. Distal end 36 of retainer spring 18 is free and extends under enlarged portion 30 of keyhole 28 and covers the entire underside of enlarged portion 30. Distal end 36, however, does not cover any portion of the underside of narrow portion 32. In operation, retainer spring 18 flexes in a downward direction and springs back to bottom surface 26 to cover the entire underside of enlarged portion 30. Also in operation, retainer spring 18 inhibits end 22 of cable 14 from slipping out of narrow portion 32 of keyhole 28 and into enlarged portion 30. Retainer spring 18 can take a variety of other forms, including, but not limited to, spot welded steel, clip on steel like a tinnerman clip, riveted plastic.

During installation, a user inserts end 22 of cable 14 into enlarged portion 30 of keyhole 28 on top surface 24 of reflector pan 16. Upon passing through enlarged portion 30, end 22 contacts retainer spring 28. Upon contacting retainer spring 18, end 22 is pressed through enlarged portion 30, causing distal end 36 of retainer spring 18 to open. That is, retainer spring 18 biases in a downward direction away from reflector pan 16. End 22 is pressed through enlarged portion 30 of keyhole 28 until all of end 22 extends below enlarged portion 30.

Body 20, which has a smaller cross-sectional extent than the width of narrow portion 32 of keyhole 28, is then slid from enlarged portion 30 into narrow portion 32 until body 20 and end 22 clear retainer spring 18. When body 20 and end 22 clear retainer spring 18, retainer spring 18 closes. That is, retainer spring 18 springs back against bottom surface 26 of reflector pan 16 covering the entire underside of enlarged portion 30 of keyhole 28. When retainer spring 18 springs back to bottom surface 26, distal end 36 of retainer spring 18 is horizontally adjacent to end 22, and end 22 is positioned vertically adjacent to bottom surface 26. When end 22 is in narrow portion 32 of keyhole 28, end 22 contacts bottom surface 26 and can contact distal end 36 of retainer spring 18. End 22 is, thus, retained in narrow portion 32 of keyhole 28 by distal end 36 and bottom surface 26 of reflector pan 16. Distal end 36 prevents end 22 from transverse movement into enlarged portion 30 of keyhole 28. Furthermore, end 22 is prevented from upward vertical movement through narrow portion 32 because the width of narrow portion 32 is less than the cross-sectional extent of end 22 and by operation of gravity. Cable 14 is, thus, prevented from accidentally disconnecting from reflector pan 16.

To uninstall light fixture 10, an instrument such as a screwdriver can be pressed into enlarged portion 30 of keyhole 28. The instrument depresses retainer spring 18 enough to allow end 22 of cable 14 to clear retainer spring 18 and reenter enlarged portion 30 of keyhole 28. End 22 then exits reflector pan 16 through enlarged portion 30, and retainer spring 18 closes.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A light fixture mounting assembly, comprising:
a cable having a body and an end, said end having a larger cross-sectional extent than said body;
a housing member having a top surface and a bottom surface, said housing member defining a keyhole through said top surface and said bottom surface, said keyhole having a circular portion and a narrower slot-shaped portion, said circular portion of said keyhole having a larger cross-sectional extent than said end of said cable, said end of said cable positioned adjacent said bottom surface and having a larger cross-sectional extent than a width of said narrower slot-shaped portion of said keyhole; and
an elastic member attached to said bottom surface of said housing member, said elastic member being under said circular portion of said keyhole and being configured for flexing in a downward direction and springing back, said elastic member having a distal end adjacent said end of said cable for retaining said end of said cable in said narrower slot-shaped portion of said keyhole.

2. The light fixture mounting assembly of claim 1, wherein said cable has one of a swaged end and a crimped end.

3. The light fixture mounting assembly of claim 1, wherein said end of said cable is cylindrical in shape.

4. The light fixture mounting assembly of claim 1, wherein said housing member defines a plurality of said keyholes through said top surface and said bottom surface.

5. The light fixture mounting assembly of claim 1, wherein said keyhole is configured for pressing said end of said cable through said enlarged portion of said keyhole and for sliding said body of said cable in said narrow portion of said keyhole.

6. The light fixture mounting assembly of claim 1, wherein said elastic member is one of a retainer spring, spot welded steel, clip on steel, and riveted plastic.

7. A light fixture, comprising:
a housing member having a top surface and a bottom surface, said housing member defining a keyhole through said top surface and said bottom surface, said keyhole having a circular portion and a narrower slot-shaped portion; and
an elastic member attached to said bottom surface of said housing member, said elastic member being under said circular portion of said keyhole and being configured for flexing in a downward direction and springing back, said elastic member extending across said circular portion and terminating at said narrower slot-shaped portion.

8. The light fixture mounting assembly of claim 7, wherein said housing member defines a plurality of said keyholes through said top surface and said bottom surface.

9. The light fixture of claim 7, wherein said elastic member is one of a retainer spring, spot welded steel, clip on steel, and riveted plastic.

10. A method of mounting a light fixture, comprising the steps of:
pressing an end of a cable into and through a circular portion of a keyhole and onto an elastic member wherein said elastic member flexes in a downward direction;
sliding said end of said cable into a narrower slot-shaped portion of said keyhole, wherein said end of said cable clears said elastic member, and said elastic member springs back to overlie said circular portion; and
retaining said end of said cable in said narrower slot-shaped portion of said keyhole by a distal end of said elastic member.

11. The method of mounting a light fixture in claim 10, wherein said end of said cable is one of a swaged end and a crimped end.

12. The method of mounting a light fixture in claim 10, wherein said cable is cylindrical in shape.

13. The method of mounting a light fixture in claim 10, wherein said elastic member is one of a retainer spring, spot welded steel, clip on steel, and riveted plastic.
